(19) United States
(12) Patent Application Publication
(10) Pub. No.: US 2025/0232900 A1
(43) Pub. Date: Jul. 17, 2025

(54) Method For Producing Soft Magnetic Alloy Powder, Soft Magnetic Alloy Powder, Dust Core, Magnetic Element, And Electronic Device

(71) Applicant: SEIKO EPSON CORPORATION, Tokyo (JP)

(72) Inventor: Mayu WATANABE, Hachinohe (JP)

(21) Appl. No.: 19/016,250

(22) Filed: Jan. 10, 2025

(30) Foreign Application Priority Data
Jan. 11, 2024 (JP) 2024-002380

(51) Int. Cl. H01F 1/153; B22F 1/05; B22F 1/142; B22F 9/08; C22C 38/00; C22C 38/02; C22C 38/12; C22C 38/16; H01F 3/08

(52) U.S. Cl. CPC H01F 1/1535; B22F 1/05; B22F 1/142; B22F 9/082; C22C 38/002; C22C 38/02; C22C 38/12; C22C 38/16; H01F 3/08

(57) ABSTRACT

A method for producing a soft magnetic alloy powder includes: a step of producing an amorphous alloy powder that has an average particle diameter of 10.0 μm or more and 45.0 μm or less and that is formed of a composition represented by a composition formula FeₓCuₐNb_{b} (Si_{1-y}B_{y})_{100-x-a-b}, where 0.3≤a≤2.0, 2.0≤b≤4.0, and 72.5≤x<75.5 are satisfied, and y is a number that satisfies f(x)≤y≤0.99, and f(x)=(4×10⁻³⁴)x^{17.56}; and a step of heating at a temperature of 500° C. or higher and 600° C. or lower to produce a soft magnetic alloy powder containing 30 vol % or more of crystal grains having a crystal grain size of 1.0 nm or more and 30.0 nm or less, and volume resistivity of a green compact is 10.0×10⁻³ [Ω·cm] or less.

The present application is based on, and claims priority from JP Application Serial Number 2024-002380, filed Jan. 11, 2024, the disclosure of which is hereby incorporated by reference herein in its entirety.

### BACKGROUND

### 1. Technical Field

The present disclosure relates to a method for producing a soft magnetic alloy powder, a soft magnetic alloy powder, a dust core, a magnetic element, and an electronic device.

### 2. Related Art

JP-A-2022-175110 discloses a soft magnetic powder including amorphous metal particles having a composition represented by a composition formula Fe_{100-a-b-c-d-e-f-g}CrₐSi_{b}B_{c}C_{d}AlₑTi_{f}Co_{g} (where a, b, c, d, e, f, and g are numbers representing atomic % and satisfy 0<a≤3.0, 5.0≤b≤15.0, 7.0≤c≤15.0, 0.1≤d≤3.0, 0<e≤0.016, 0<f≤0.009, and 0≤g≤0.025). According to such a configuration, it is possible to obtain a soft magnetic powder that has good magnetic properties due to an amorphous alloy and also has low coercive force.

JP-A-2022-175110 discloses that a heat treatment is performed in the production of the soft magnetic powder. By performing the heat treatment, it is possible to reduce various defects and anisotropy (stress-induced anisotropy) that are introduced during the production of the soft magnetic powder. Accordingly, the low coercive force can be achieved. Further, JP-A-2022-175110 discloses that a heating temperature in the heat treatment is set to a temperature lower than a crystallization temperature of the amorphous metal particles.

However, from the viewpoint of further reliably reducing the coercive force, a method for producing the soft magnetic powder described in JP-A-2022-175110 still has room for improvement. For example, even when the heat treatment is performed, the coercive force of some particles may not sufficiently decrease. Therefore, there is a problem to improve the production method so that the coercive force can be more reliably reduced without impairing production efficiency of the soft magnetic powder.

### SUMMARY

A method for producing a soft magnetic alloy powder according to an application example of the present disclosure includes:
a powder production step of producing an amorphous alloy powder that has an average particle diameter of 10.0 μm or more and 45.0 μm or less and that is formed of impurities and a composition represented by a composition formula FeₓCuₐNb_{b}(Si_{1-y}B_{y})_{100-x-a-b} in atomic ratio, where a, b, and x satisfy

0.3≤a≤2.0,

2.0≤b≤4.0, and

72.5≤x<75.5, and
y is a number that satisfies f(x)≤y≤0.99, and f(x)=(4×10⁻³⁴)x^{17.56}; and
a heat treatment step of subjecting the amorphous alloy powder to a heat treatment at a temperature of 500° C. or higher and 600° C. or lower to crystallize the amorphous alloy powder, to produce a soft magnetic alloy powder containing 30 vol % or more of crystal grains having a crystal grain size of 1.0 nm or more and 30.0 nm or less,
when the soft magnetic alloy powder is pressurized at a pressure of 63.7 MPa to produce a green compact having a mass of 7.0 g, volume resistivity of the green compact is 10.0×10⁻³ [Ω·cm] or less.

A soft magnetic alloy powder according to an application example of the present disclosure includes:
impurities and a composition represented by a composition formula FeₓCuₐNb_{b} (Si_{1-y}B_{y})_{100-x-a-b} in atomic ratio, where a, b, and x are each a number expressed in atomic %, which satisfy

0.3≤a≤2.0,

2.0≤b≤4.0, and

72.5≤x<75.5, and
y is a number that satisfies f(x)≤y≤0.99, and f(x)=(4×10⁻³⁴)x^{17.56},
the soft magnetic alloy powder has an average particle diameter of 10.0 μm or more and 45.0 μm or less, and contains 30 vol % or more of crystal grains having a crystal grain size of 1.0 nm or more and 30.0 nm or less, and
when the soft magnetic alloy powder is pressurized at a pressure of 63.7 MPa to produce a green compact having a mass of 7.0 g, volume resistivity of the green compact is 10.0×10⁻³ [Ω·cm] or less.

A dust core according to an application example of the present disclosure includes:
the soft magnetic alloy powder according to the application example of the present disclosure.

A magnetic element according to an application example of the present disclosure includes:
a dust core according to the application example of the present disclosure.

An electronic device according to an application example of the present disclosure includes:
the magnetic element according to the application example of the present disclosure.

### BRIEF DESCRIPTION OF THE DRAWINGS

FIG. 1 is a diagram showing regions A to C representing compositions of a soft magnetic alloy powder according to an embodiment in a two-axis orthogonal coordinate system with x being a horizontal axis and y being a vertical axis.

FIG. 2 is a process diagram showing a configuration of a method for producing the soft magnetic alloy powder according to the embodiment.

FIG. 3 is a plan view schematically showing a toroidal type coil component.

FIG. 4 is a transparent perspective view schematically showing a closed magnetic circuit type coil component.

FIG. 5 is a perspective view showing a mobile personal computer which is an electronic device including a magnetic element according to the embodiment.

FIG. 6 is a plan view showing a smartphone which is an electronic device including the magnetic element according to the embodiment.

FIG. 7 is a perspective view showing a digital still camera which is an electronic device including the magnetic element according to the embodiment.

### DESCRIPTION OF EMBODIMENTS

Hereinafter, a method for producing a soft magnetic alloy powder, a soft magnetic alloy powder, a dust core, a magnetic element, and an electronic device according to the present disclosure will be described in detail based on preferred embodiments shown in the accompanying drawings.

### 1. Soft Magnetic Alloy Powder

First, a soft magnetic alloy powder according to an embodiment will be described.

The soft magnetic alloy powder is applicable to any application, and is used, for example, for the production of a dust core. The dust core is produced by bonding particles of the soft magnetic alloy powder together and compacting the particles.

The soft magnetic alloy powder according to the embodiment contains impurities and a composition represented by a composition formula FeₓCuₐNb_{b} (Si_{1-y}B_{y})_{100-x-a-b} in atomic ratio.

a, b, and x satisfy 0.3≤a≤ 2.0, 2.0≤b≤4.0, and 72.5≤x<75.5. In addition, y is a number satisfying f(x)≤y≤0.99, and f(x)=(4×10⁻³⁴)x^{17.56}.

The soft magnetic alloy powder according to the embodiment has an average particle diameter of 10.0 μm or more and 45.0 μm or less.

Further, the soft magnetic alloy powder according to the embodiment contains 30 vol % or more of crystal grains having a crystal grain size of 1.0 nm or more and 30.0 nm or less. The crystal grains are formed by subjecting an amorphous alloy powder as a precursor to a heat treatment under predetermined conditions to crystallize the amorphous alloy powder during production of the soft magnetic alloy powder.

The soft magnetic alloy powder formed through such a heat treatment is a powder in which, when pressed at a pressure of 63.7 MPa to produce a green compact having a mass of 7.0 g, a volume resistivity of the green compact is 10.0×10⁻³ [Ω·cm] or less.

By producing the green compact so that its volume resistivity falls within the above range, a soft magnetic alloy powder having a low coercive force is obtained. When the volume resistivity of the above-described green compact is within the above range, a variation in coercive force of the soft magnetic alloy powder can be reduced. That is, the soft magnetic alloy powder produced so that the volume resistivity of the above-described green compact falls within the above range can be said to have a homogeneity that minimizes the variation in measurement values, for example when the powder is divided into a plurality of particle groups and the coercive force of each group is measured. In other words, such a soft magnetic alloy powder is a powder in which each particle stably receives the effect of the heat treatment and has a low coercive force. Therefore, by producing a product such as a dust core using such a soft magnetic alloy powder, a product with stable properties and little individual variation can be produced.

### 1.1. Composition

Hereinafter, a composition of the soft magnetic alloy powder will be described in detail. As described above, the soft magnetic alloy powder according to the embodiment has a composition represented by a composition formula FeₓCuₐNb_{b} (Si_{1-y}B_{y})_{100-x-a-b}. The composition formula represents a ratio in terms of the number of atoms in a composition containing five elements of Fe, Cu, Nb, Si, and B.

Fe (iron) greatly affects basic magnetic properties and mechanical properties of the soft magnetic alloy powder according to the embodiment.

The content x of Fe is 72.5 atomic % or more and less than 75.5 atomic %, preferably 72.8 atomic % or more and 75.0 atomic % or less, and more preferably 73.0 atomic % or more and 74.5 atomic % or less. When the content x of Fe is less than the lower limit value, a saturation magnetic flux density of the soft magnetic alloy powder may decrease. On the other hand, when the content x of Fe is more than the upper limit value, an amorphous structure cannot be stably formed during the production of the soft magnetic alloy powder, and thus it may be difficult to form crystal grains having a minute grain size as described above. In addition, the coercive force of the soft magnetic alloy powder may increase.

When the soft magnetic alloy powder according to the embodiment is produced from raw materials, Cu (copper) tends to separate from Fe. Therefore, the containing of Cu causes a fluctuation in the composition, resulting in regions within the particles that are likely to be crystallized. As a result, precipitation of a body-centered cubic lattice Fe phase, which is relatively likely to be crystallized, is promoted, making it easier to form crystal grains.

The content a of Cu is 0.3 atomic % or more and 2.0 atomic % or less, preferably 0.5 atomic % or more and 1.5 atomic % or less, and more preferably 0.7 atomic % or more and 1.3 atomic % or less. When the content a of Cu is less than the lower limit value, the refinement of crystal grains is impaired, and the crystal grains having a grain size within the above-described range may not be formed. On the other hand, when the content a of Cu is more than the upper limit value, the mechanical properties of the particles may decrease and may become brittle.

Nb (niobium) contributes to the refinement of the crystal grains together with Cu when subjected to the heat treatment. Therefore, it is possible to easily form the crystal grains having a minute grain size as described above.

The content b of Nb is 2.0 atomic % or more and 4.0 atomic % or less, preferably 2.5 atomic % or more and 3.5 atomic % or less, and more preferably 2.7 atomic % or more and 3.3 atomic % or less. When the content b of Nb is less than the lower limit value, the refinement of crystal grains is impaired, and the crystal grains having a grain size within the above-described range may not be formed. On the other hand, when the content b of Nb is more than the upper limit value, the mechanical properties of the particles may decrease and may become brittle. In addition, permeability of the soft magnetic alloy powder may decrease.

Silicon (Si) promotes amorphization when the soft magnetic alloy powder according to the embodiment is produced from a raw material. Therefore, when the soft magnetic alloy powder according to the embodiment is produced, a homogeneous amorphous structure is first formed, and then, by crystallizing the amorphous structure, crystal grains having a more uniform grain size are easily formed. Further, a uniform grain size contributes to averaging out magnetocrystalline anisotropy in each of crystal grains, thereby reducing the coercive force and enhancing the permeability, which contributes to improving the soft magnetic properties.

B (boron) promotes amorphization when the soft magnetic alloy powder according to the embodiment is produced from a raw material. Therefore, when the soft magnetic alloy powder according to the embodiment is produced, a homogeneous amorphous structure is first formed, and then, by crystallizing the amorphous structure, crystal grains having a more uniform grain size are easily formed. The uniform grain size contributes to improving the soft magnetic properties. By using Si and B in combination, the amorphization can be synergistically promoted based on a difference in an atomic radius between Si and B.

Here, when a total content of Si and B is 1 and a ratio of the content of B to the total is y, a ratio of the content of Si to the total is 1-y.

The y is a number that satisfies f(x)≤y≤0.99. Further, f(x), which is a function of x, is f(x)=(4×10⁻³⁴)x^{17.56}.

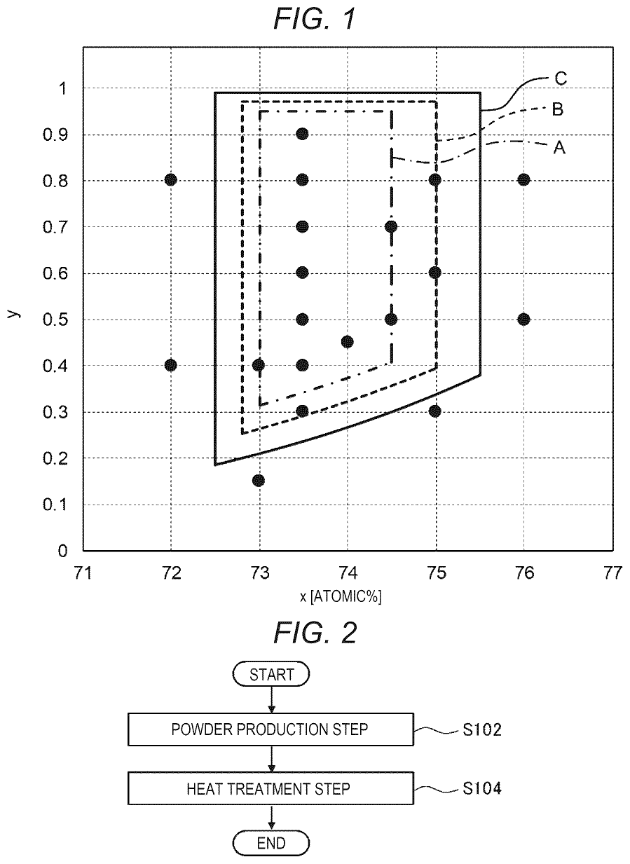

FIG. 1 is a diagram showing regions A to C representing compositions of a soft magnetic alloy powder according to an embodiment in a two-axis orthogonal coordinate system with x being a horizontal axis and y being a vertical axis.

In FIG. 1, the region C is inside a solid line drawn in an orthogonal coordinate system. Specifically, the region C is a closed region surrounded by three drawn straight lines and one curve when (x,y) coordinates satisfying four expressions of x=72.5, x=75.5, y=f(x), and y=0.99 are plotted on the orthogonal coordinate system. However, the straight line of x=75.5 is not included.

In addition, y is preferably a number that satisfies f′(x)≤y≤0.97. f′ (x) is f′ (x)=(4×10⁻²⁹)x^{14.93}.

In FIG. 1, the region B is inside a dashed line drawn in the orthogonal coordinate system. Specifically, the region B is a closed region surrounded by three drawn straight lines and one curve when (x,y) coordinates satisfying four expressions of x=72.8, x=75.0, y=f′ (x), and y=0.97 are plotted on the orthogonal coordinate system.

Further, y is more preferably a number that satisfies f″ (x)≤y≤0.95. f″ (x) is f″ (x)=(4×10⁻²⁹) x^{14.93}+0.05.

In FIG. 1, the region A is inside a dash-dotted line drawn in the orthogonal coordinate system. Specifically, the region A corresponds to a closed region surrounded by three drawn straight lines and one curve when (x,y) coordinates satisfying four expressions of x=73.0, x=74.5, y=f″ (x), and y=0.95 are plotted on the orthogonal coordinate system.

The soft magnetic alloy powder whose composition is contained in the region C can form a homogeneous amorphous structure with high probability when produced. Therefore, by crystallizing the amorphous structure, crystal grains having a particularly uniform and fine grain size can be formed. Accordingly, a soft magnetic alloy powder with a sufficiently reduced coercive force and enhanced permeability is obtained.

The soft magnetic alloy powder having the composition in the region C can enable formation of uniform crystal grains even when the content of Fe is sufficiently increased. Accordingly, a soft magnetic alloy powder having sufficiently enhanced permeability and saturation magnetic flux density is obtained.

When a value of y is smaller than that of the region C, a balance between the content of Si and the content of B is lost, and thus it is difficult to form a homogeneous amorphous structure when the soft magnetic alloy powder is produced. Therefore, crystal grains having a minute grain size cannot be formed, and the coercive force cannot be sufficiently reduced.

On the other hand, when the value of y is larger than that of the region C, the balance between the content of Si and the content of B is also lost, and thus it is difficult to form a homogeneous amorphous structure when the soft magnetic alloy powder is produced. Therefore, crystal grains having a minute grain size cannot be formed, and the coercive force cannot be sufficiently reduced.

A lower limit value of y is preferably 0.30 or more, more preferably 0.45 or more, and still more preferably 0.55 or more. Accordingly, it is possible to achieve a higher saturation magnetic flux density d and higher permeability for the soft magnetic alloy powder.

In particular, in the region B and the region A, by reducing the content of Fe, it is possible to achieve a low coercive force while preventing a decrease in the permeability of the soft magnetic alloy powder.

A total of the content of Si and the content of B, which is (100-x-a-b), is not particularly limited, and is preferably 15.0 atomic % or more and 24.0 atomic % or less, more preferably 18.0 atomic % or more and 23.5 atomic % or less, and still more preferably 20.0 atomic % or more and 23.0 atomic % or less. By setting (100-x-a-b) within the above range, crystal grains having a particularly uniform grain size can be formed in the soft magnetic alloy powder.

Note that, y(100-x-a-b) corresponds to the content of B in the soft magnetic alloy powder. y(100-x-a-b) is appropriately set in consideration of the coercive force, the saturation magnetic flux density, and the like as described above, and preferably satisfies 5.0≤y(100-x-a-b)≤ 17.0, more preferably satisfies 7.0≤y(100-x-a-b)≤ 16.0, and still more preferably satisfies 8.0≤y(100-x-a-b)≤15.0.

Accordingly, a soft magnetic alloy powder containing B (boron) at a relatively high concentration is obtained. Such a soft magnetic alloy powder enables formation of a homogeneous amorphous structure during its production even when the content of Fe is high. Therefore, by the subsequent heat treatment, it is possible to form crystal grains having a minute grain size and a relatively uniform grain size, and it is possible to achieve a high saturation magnetic flux density and high permeability while sufficiently reducing the coercive force.

When y(100-x-a-b) is less than the lower limit value, the content of B is small, and therefore, it may be difficult to make the soft magnetic alloy powder amorphous depending on the entire composition in the production of the soft magnetic alloy powder. Accordingly, achievement of a low coercive force may be hindered. On the other hand, when y(100-x-a-b) is more than the upper limit value, the content of B is large and the content of Si relatively decreases, and therefore, the permeability of the soft magnetic alloy powder may decrease and the saturation magnetic flux density may decrease.

The soft magnetic alloy powder according to the embodiment may contain impurities in addition to the composition represented by FeₓCuₐNb_{b} (Si_{1-y}B_{y})_{100-x-a-b} described above. Examples of the impurities include all elements other than those described above, and a total content of impurities is preferably 0.50 atomic % or less. As long as the content is within the above range, the impurities are less likely to hinder the effect of the embodiment, and thus the impurities are allowed to be contained.

The content of each element of the impurities is preferably 0.05 atomic % or less. As long as the content is within the above range, the impurities are less likely to hinder the effect of the embodiment, and thus the impurities are allowed to be contained.

Although the composition and the impurities of the soft magnetic alloy powder according to the embodiment are described, the composition and the impurities are identified by the following analysis method.

Examples of the analysis method include iron and steel-atomic absorption spectrometry defined in JIS G 1257:2000, iron and steel-ICP emission spectrometry defined in JIS G 1258:2007, iron and steel-spark discharge emission spectrometry defined in JIS G 1253:2002, iron and steel-fluorescent X-ray spectrometry defined in JIS G 1256:1997, and gravimetric, titration and absorption spectrometric methods defined in JIS G 1211 to JIS G 1237.

Specifically, examples thereof include a solid-state optical emission spectrometer manufactured by SPECTRO, in particular a spark discharge optical emission spectrometer, model: SPECTROLAB, type: LAVMB08A, and an ICP device CIROS120 manufactured by Rigaku Corporation.

In particular, when identifying carbon (C) and sulfur(S), an infrared absorption method after combustion in a current of oxygen (combustion in high frequency induction furnace) defined in JIS G 1211:2011 is also used. Specifically, examples thereof include a carbon-sulfur analyzer CS-200 made by LECO Corporation.

When nitrogen (N) and oxygen (O) are identified, methods for determination of nitrogen content for an iron and steel defined in JIS G 1228:1997 and general rules for determination of oxygen in metal materials defined in JIS Z 2613:2006 are also used. Specifically, examples thereof include an oxygen and nitrogen analyzer, TC-300/EF-300, manufactured by LECO Corporation.

### 1.2. Crystal Grains

The soft magnetic alloy powder particles according to the embodiment have crystal grains having a grain size of 1.0 nm or more and 30.0 nm or less.

The crystal grains are formed of, for example, Fe—Si crystals. The Fe—Si crystal has a characteristic of a high saturation magnetic flux density, which is unique to a Fe—Si composition. Further, since a number density of the crystal grains is increased by achieving the refinement of the crystal grains including the Fe—Si crystal and uniformity of the grain size, the saturation magnetic flux density of the crystal grains is less likely to decrease even when the crystal grains are refined. Therefore, the soft magnetic alloy powder can achieve a high saturation magnetic flux density.

In addition, in the grains, since the refinement in the crystal grains is achieved, the magnetocrystalline anisotropy in the crystal grains is easily averaged. Therefore, even when the Fe concentration is high, an increase in the coercive force can be prevented. Therefore, it is possible to reduce the coercive force of the grains. When such crystal grains are contained in a large amount, the permeability of the grains is enhanced.

From the above, it is possible to increase the saturation magnetic flux density and the permeability of the particles while achieving a low coercive force.

In the grains, a content ratio of the crystal grains is 30 vol % or more, preferably 40 vol % or more and 99 vol % or less, and more preferably 55 vol % or more and 95 vol % or less. When the content ratio of the crystal grains is less than the lower limit value, a ratio of the crystal grains decreases, so that the averaging of the magnetocrystalline anisotropy is insufficient, and the permeability of the soft magnetic alloy powder may decrease or the coercive force may increase. The saturation magnetic flux density may decrease, and an iron loss of the dust core may increase. On the other hand, the content ratio of the crystal grains may be more than the upper limit value, but instead, it is considered that a content ratio of crystal grain boundaries, which is to be described later, decreases. In this case, a situation in which the crystal grains are likely to grow rapidly occurs, and even a slight deviation in a heat treatment temperature and the like may lead to the crystal grains becoming coarse. Accordingly, a decrease in the permeability and an increase in the coercive force of the soft magnetic alloy powder may occur.

The content ratio of the crystal grains is a volume ratio, but since it is considered to be approximately equal to an area ratio that the crystal grains occupy with respect to an area of a cut surface, the area ratio may be regarded as the content ratio. Therefore, the content ratio of the crystal grains is determined as a ratio of the area occupied by the crystal grains to the entire area of the above-described range in an observation image.

The grain size of the crystal grains is determined by observing a cut surface of the grain under an electron microscope and reading the grain size from a 200 nm square area centered at a depth of 5 μm from a surface in the observation image. In this method, a perfect circle having an area same as the area of the crystal grain is assumed, and a diameter of the perfect circle, that is, an equivalent circle diameter, can be taken as the grain size of the crystal grain. As the electron microscope, for example, a scanning transmission electron microscope (STEM) is used.

An average grain size can be determined by averaging the grain sizes of the crystal grains that are read. The average grain size of the crystal grains is preferably 2.0 nm or more and 25.0 nm or less, and more preferably 5.0 nm or more and 20.0 nm or less. Accordingly, the above effect, that is, the effect that the coercive force is low and the permeability is high, and the effect that the saturation magnetic flux density is high and the iron loss of the dust core is low become more remarkable. The average grain size of the crystal grains is calculated based on 10 or more grain sizes.

The grains may include crystal grains having a grain size outside the above-described range, that is, crystal grains having a grain size of less than 1.0 nm or more than 30.0 nm.

The fact that the crystal grains contain the Fe—Si crystals can be identified by an energy dispersive X-ray spectroscopy (EDX) analysis using a STEM. Specifically, first, an observation image of a cross section of grains is obtained by the STEM. The crystal grains are identified from the observation image. Next, the EDX analysis is performed using the STEM, and a quantitative analysis of each element is performed based on an analysis result using a quantification method. When the Fe concentration is the highest and the Si concentration is the second highest in terms of atomic ratio in the crystal grains, it can be said that the crystal grains contain the Fe—Si crystals.

As the STEM, for example, JEM-ARM200F manufactured by JEOL Ltd. can be used. As the EDX analyzer, an NSS7 manufactured by Thermo Fisher Scientific can be used. An acceleration voltage during analysis is set to 120 kV, and Cliff-Lorimer (MBTS) that does not take absorption correction into account is used in the quantification method using an EDX spectrum.

### 1.3. Various Properties

An average particle diameter of the soft magnetic alloy powder is 10.0 μm or more and 45.0 μm or less, preferably 15.0 μm or more and 40.0 μm or less, and more preferably 20.0 μm or more and 30.0 μm or less. By using the soft magnetic alloy powder having such an average particle diameter, it is possible to shorten a path through which an eddy current flows, and therefore, it is possible to produce a dust core capable of sufficiently reducing an eddy current loss that occurs in the particles.

In particular, when the average particle diameter of the soft magnetic alloy powder is equal to or greater than the lower limit value, a high green compact molding density can be achieved by mixing with a soft magnetic powder having an average particle diameter smaller than that of the soft magnetic alloy powder according to the embodiment.

The average particle diameter of the soft magnetic alloy powder is determined as a particle diameter D50 at 50% cumulative from a small diameter side in a volume-based particle size distribution obtained by a laser diffraction method.

When the average particle diameter of the soft magnetic alloy powder is less than the above lower limit value, the soft magnetic alloy powder is too fine, and thus filling properties of the soft magnetic alloy powder may easily decrease. Accordingly, since the molding density of the dust core, which is an example of a green compact, decreases, the saturation magnetic flux density and the permeability of the dust core may decrease. In addition, crystallization due to the heat treatment may occur. On the other hand, when the average particle diameter of the soft magnetic alloy powder is more than the upper limit value, the particle diameter is too large, and therefore, an amorphous alloy powder as a precursor of the soft magnetic alloy powder may not be sufficiently amorphized. The relaxation of a stress strain due to the heat treatment may be insufficient, making it difficult to achieve a low coercive force.

For the soft magnetic alloy powder, in the volume-based particle size distribution obtained by the laser diffraction method, when a particle diameter at 10% cumulative from the small diameter side is defined as D10 and a particle diameter at 90% cumulative from the small diameter side is defined as D90, it is preferable that (D90−D10)/D50 is about 1.0 or more and 2.5 or less, and more preferably about 1.2 or more and 2.3 or less. (D90−D10)/D50 is an index showing a degree of spread of particle size distribution, and by having the index within the above range, the filling properties of the soft magnetic alloy powder is good. Therefore, it is possible to obtain a green compact having particularly high magnetic properties such as the permeability and the saturation magnetic flux density.

The coercive force of the soft magnetic alloy powder is preferably 8.0 [A/m] (0.1 [Oe]) or more and 79.6 [A/m] (1.0 [Oe]) or less, more preferably 15.9 [A/m] (0.2 [De]) or more and 63.7 [A/m] (0.8 [De]) or less, and still more preferably 23.9 [A/m] (0.3 [De]) or more and 47.8 [A/m] (0.6 [Oe]) or less. By using the soft magnetic alloy powder having a small coercive force as described above, it is possible to produce a dust core in which a hysteresis loss is sufficiently reduced.

When the coercive force is less than the lower limit value, it is difficult to stably produce such a soft magnetic alloy powder having a low coercive force, and when the coercive force is pursued too much, the permeability may be adversely affected. On the other hand, when the coercive force is more than the upper limit value, the hysteresis loss is increased, and thus an iron loss of the dust core may be increased.

The coercive force of the soft magnetic alloy powder can be measured, for example, by a vibrating sample magnetometer such as TM-VSM1230-MHHL manufactured by Tamakawa Co., Ltd.

When a maximum magnetization of the soft magnetic alloy powder is Mm [emu/g] and a true density of the particles is ρ [g/cm³], a saturation magnetic flux density Bs [T] determined by 4π/10000×ρ×Mm=Bs is preferably 1.0 [T] or more, and more preferably 1.1 [T] or more. By using the soft magnetic alloy powder having such a high saturation magnetic flux density, it is possible to implement a dust core which is less likely to be saturated even with a high current.

The true density p of the soft magnetic alloy powder is measured using a fully automatic gas displacement densitometer, AccuPyc1330, manufactured by Micromeritics Corporation. The maximum magnetization Mm of the soft magnetic alloy powder is measured using a vibrating sample magnetometer, VSM system TM-VSM1230-MHHL manufactured by Tamagawa Seisakusho Co., Ltd.

### 2. Method for Producing Soft Magnetic Alloy Powder

Next, a method for producing the soft magnetic alloy powder according to the embodiment will be described.

FIG. 2 is a process diagram showing a configuration of a method for producing the soft magnetic alloy powder according to the embodiment.

The method for producing the soft magnetic alloy powder shown in FIG. 2 includes a powder production step S102 and a heat treatment step S104.

### 2.1. Powder Production Step

In the powder production step S102, a powder before the heat treatment (amorphous alloy powder) is produced.

The amorphous alloy powder is a powder formed of an amorphous alloy containing impurities and a composition represented a by composition formula FeₓCuₐNb_{b} (Si_{1-y}B_{y})_{100-x-a-b} in atomic ratio [where a, b, and x satisfy 0.3≤a≤ 2.0, 2.0≤b≤4.0, and 72.5≤x<75.5. In addition, y is a number that satisfies f(x)≤y≤0.99, and f(x)=(4×10⁻³⁴)x^{17.56}]. The amorphous alloy powder has an average particle diameter of 10.0 μm or more and 45.0 μm or less.

Such an amorphous alloy powder may have a stress strain in a production process or the like. Therefore, by subjecting the amorphous alloy powder to a heat treatment to be described later, the stress strain is relaxed, and the amorphous alloy powder is crystallized.

A degree of crystallinity of each particle of the amorphous alloy powder is less than 50%, and preferably 30% or less. The degree of crystallinity is calculated based on the following formula by obtaining an X-ray diffraction spectrum for the amorphous alloy powder.

$$Degree of crystallinity = \{ crystal - derived intensity / ( crystal - derived intensity + amorphous - derived intensity ) \} \times 100$$

The amorphous alloy powder may be produced by any production method, and may be produced by, for example, various powdering methods such as atomization methods such as a water atomization method, a gas atomization method, and a rotary water jet atomization method, a reduction method, a carbonyl method, and a pulverization method.

The atomization method is a method for producing a powder by pulverizing a molten raw material and cooling it at the same time by colliding it with a fluid such as a liquid or a gas ejected at a high speed. Examples of the atomization method include a water atomization method, a gas atomization method, and a rotary water jet atomization method, depending on a difference in a type of a cooling medium and a device configuration. Among these, the amorphous alloy powder is preferably produced by the water atomization method or the rotary water jet atomization method, and more preferably produced by the rotary water jet atomization method.

Among these, the “water atomization method” in the present specification refers to a method for producing a metal powder by using a liquid such as water or oil as a coolant, ejecting it in an inverted cone shape that converges to one point, and then allowing a molten metal to flow down toward the convergence point and collide with liquid.

The “rotary water jet atomization method” in the specification is a method in which a coolant is sprayed and supplied along an inner surface of a cooling cylinder and rotated to form a coolant layer on the inner surface, and a molten metal made by melting an amorphous alloy powder raw material is splashed and brought into contact with the coolant layer. The pulverized molten metal is captured in the coolant layer and is rapidly cooled and solidified. Accordingly, it is possible to obtain the amorphous alloy powder.

In the rotary water jet atomization method, a fairly high cooling rate can be stably maintained by continuously supplying the coolant, which promotes the amorphization of the produced amorphous alloy powder.

The amorphous alloy powder may be subjected to a classification process as necessary. Examples of the classification process include dry classification such as sieving classification, inertial classification, centrifugal classification, and air classification, and wet classification such as sedimentation classification.

### 2.2. Heat Treatment Step

In the heat treatment step S104, the amorphous alloy powder is subjected to the heat treatment at a temperature of 500° C. or higher and 600° C. or lower. Accordingly, the stress strain of the amorphous alloy powder can be relaxed, and it is possible to obtain the soft magnetic alloy powder having a low coercive force. By crystallizing the amorphous alloy powder, a soft magnetic alloy powder containing crystal grains with a crystal grain size of 1.0 nm or more and 30.0 nm or less is obtained.

The volume resistivity of the green compact produced using the obtained soft magnetic alloy powder is 10.0×10⁻³ [Q·cm] or less. Accordingly, it is possible to reduce the variation in the coercive force of the soft magnetic alloy powder to be produced. The reason why such an effect is obtained is that when the volume resistivity is within the above range, the stress strain is likely to be relaxed in an atomic arrangement or the like. That is, when the volume resistivity of the soft magnetic alloy powder is within the above range, it is considered that the progress of the heat treatment is less likely to be affected even when a temperature, a time, and the like of the heat treatment vary for each particle. Therefore, it is possible to achieve a low coercive force of the soft magnetic alloy powder as a whole, and also to form minute crystal grains having a uniform grain size. In addition, since defective particles due to insufficient or excessive heat treatment are less likely to be generated, the soft magnetic alloy powder satisfying a predetermined coercive force and having stable quality can be efficiently produced.

It is considered that the volume resistivity of the green compact is related to presence or absence of an oxide on a particle surface. Therefore, in the production process or the subsequent heat treatment of the amorphous alloy powder, the prevention of the generation of an oxide is one of methods for reducing the volume resistivity.

The volume resistivity of the green compact is preferably 9.0×10⁻³ [Ω·cm] or less, and more preferably 7.0×10⁻³ [Ω·cm] or less. Meanwhile, from the viewpoint of efficient and stable production, a lower limit value of the volume resistivity of the green compact is preferably 1.0×10⁻³ [Ω·cm] or more, and more preferably 3.0×10⁻³ [Ω·cm] or more.

A method for measuring the volume resistivity of the green compact is as follows.

First, 7.0 g of the soft magnetic alloy powder as a sample is put into a sample container of a powder resistivity measurement probe unit. An inner radius of the sample container is 10.0 mm. A radius of electrodes provided in the sample container is 0.7 mm, an electrode interval is 3.0 mm, and the probe is a four-point probe. Next, the sample is gradually pressurized by a hydraulic pump attached to the unit to prepare a cylindrical green compact having a mass of 7.0 g. With a pressure of 63.7 MPa applied to the green compact, the volume resistivity of the green compact is measured by a resistivity meter connected to the unit. The powder resistivity measurement probe unit used is a powder resistivity measurement system manufactured by Nitto Seiko Analytech Co., Ltd. As the resistivity meter, a low resistivity meter Loresta GP manufactured by Nitto Seiko Analytech Co., Ltd. is used.

The temperature of the heat treatment is 500° C. or higher and 600° C. or lower, preferably 520° C. or higher and 590° C. or lower, and more preferably 540° C. or higher and 580° C. or lower. When the temperature of the heat treatment is within the above range, the amorphous alloy powder can be appropriately crystallized while the stress strain can be sufficiently relaxed.

When the temperature of the heat treatment is less than the lower limit value, the stress strain cannot be sufficiently relaxed, and the coercive force increases. In addition, the crystallization is insufficient. On the other hand, when the temperature of the heat treatment is more than the upper limit value, the crystallization proceeds excessively, resulting in large crystal grains.

A time for which the temperature is maintained in the heat treatment (heat treatment time) is preferably 5 minutes or longer and 60 minutes or shorter, more preferably 7 minutes or longer and 45 minutes or shorter, and still more preferably 10 minutes or longer and 30 minutes or shorter. When the heat treatment time is within the above range, the amorphous alloy powder can be appropriately crystallized, and the stress strain can be sufficiently relaxed.

When the heat treatment time is less than the lower limit value, the stress strain cannot be sufficiently relaxed, and the coercive force may increase. On the other hand, when the heat treatment time is more than the upper limit value, further effects cannot be expected, and energy efficiency of the heat treatment may decrease. In addition, the crystallization may proceed excessively.

The heat treatment is performed using, for example, a heat treatment furnace. A pressure in the heat treatment furnace may be an atmospheric pressure, a negative pressure, or a positive pressure. Among these, the positive pressure is preferable. By performing the heat treatment under the positive pressure in the heat treatment furnace, a thermal conductivity of surroundings of the amorphous alloy powder in the heat treatment furnace can be enhanced. Accordingly, the temperature of the amorphous alloy powder can be increased evenly throughout, thereby enabling the soft magnetic alloy powder as a whole to have a lower coercive force.

The pressure in the heat treatment furnace is preferably 5 Pa or more and 1000 Pa or less, more preferably 10 Pa or more and 700 Pa or less, and still more preferably 30 Pa or more and 500 Pa or less. When the pressure in the heat treatment furnace is within the above range, the soft magnetic alloy powder as a whole can have a lower coercive force. In particular, a gas is present in a narrow space between particles of the amorphous alloy powder, and the gas mediates thermal conduction while being affected by a distance between the particles. Therefore, it is considered that a thermal conductivity between the particles is likely to be affected by the pressure.

When the pressure in the heat treatment furnace is less than the lower limit value, the temperature and the like of the heat treatment are likely to vary for each particle, and the heat treatment may be insufficient or excessive in a part. On the other hand, when the pressure in the heat treatment furnace is more than the upper limit value, further effects cannot be expected, and energy efficiency of the heat treatment may decrease.

For example, the positive pressure of 10 Pa is a pressure higher than the atmospheric pressure by 10 Pa, and for example, when the atmospheric pressure is 101.3 kPa, the positive pressure refers to 101.31 kPa.

An atmosphere in the heat treatment furnace is not particularly limited, and may be an acidic atmosphere, a reducing atmosphere, or the like, and is preferably an inert atmosphere, more preferably an inert atmosphere having an oxygen volume concentration of 1500 ppm or less, still more preferably an inert atmosphere having an oxygen volume concentration of 200 ppm to 1000 ppm, and particularly preferably an inert atmosphere having an oxygen volume concentration of 300 ppm to 700 ppm. When the oxygen volume concentration in the inert atmosphere is within the above range, oxidation of the amorphous alloy powder can be prevented more reliably. Therefore, the formation of an oxide film on a surface of the particle can be prevented, and the increase in the volume resistivity of the green compact can be prevented. In addition, when an oxide film is formed, the stress strain may be less likely to be relaxed. In view of this, when the oxygen volume concentration is within the above range, the coercive force of the amorphous alloy powder can be favorably reduced by the heat treatment.

Examples of the inert gas constituting the inert atmosphere include a nitrogen gas and an argon gas.

### 3. Dust Core and Magnetic Element

Next, the dust core and the magnetic element according to the embodiment will be described.

The magnetic element according to the embodiment can be applied to various magnetic elements including a magnetic core, such as choke coils, an inductor, a noise filter, a reactor, a transformer, a motor, an actuator, an electromagnetic valve, and a generator. The dust core according to the embodiment can be applied to a magnetic core provided to these magnetic elements. Hereinafter, two types of coil components will be representatively described as an example of the magnetic element.

### 3.1. Toroidal Type

First, a toroidal type coil component, which is the magnetic element according to the embodiment, will be described.

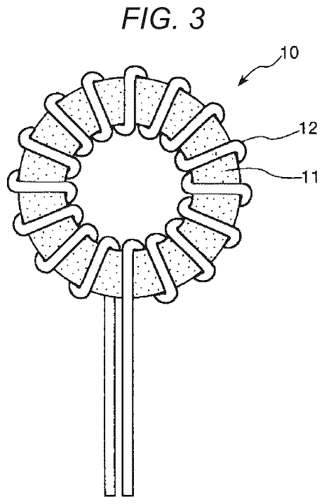

FIG. 3 is a plan view schematically showing the toroidal type coil component. A coil component 10 shown in FIG. 3 includes a ring-shaped dust core 11 and a conductive wire 12 wound around the dust core 11.

The dust core 11 is obtained by mixing the soft magnetic alloy powder described above and a binder, supplying the obtained mixture to a mold, and pressurizing and molding. That is, the dust core 11 is a green compact containing the soft magnetic alloy powder according to the embodiment. Such a dust core 11 has a low coercive force and a low iron loss.

The coil component 10 includes the dust core 11. Such a coil component 10 has a low iron loss and contributes to power saving of an electronic device.

Examples of a constituent material of the binder used for producing the dust core 11 include organic materials such as silicone-based resins, epoxy-based resins, phenol-based resins, polyamide-based resins, polyimide-based resins, and polyphenylene sulfide-based resins, and inorganic materials such as phosphates such as magnesium phosphate, calcium phosphate, zinc phosphate, manganese phosphate, and cadmium phosphate, and silicates such as sodium silicate.

Examples of a constituent material of the conductive wire 12 include a material having high conductivity, for example, a metal material including Cu, Al, Ag, Au, and Ni. An insulating coating film is provided on a surface of the conductive wire 12 as necessary.

A shape of the dust core 11 is not limited to the ring shape shown in FIG. 3, and may be, for example, a shape in which a part of the ring is missing, or a shape in which a shape in a longitudinal direction is linear.

The dust core 11 may contain, as necessary, a soft magnetic powder other than the soft magnetic alloy powder according to the embodiment described above, or a non-magnetic powder.

### 3.2. Closed Magnetic Circuit Type

Next, a closed magnetic circuit type coil component, which is the magnetic element according to the embodiment, will be described.

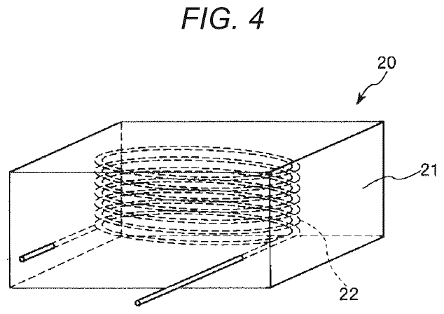

FIG. 4 is a transparent perspective view schematically showing the closed magnetic circuit type coil component.

Hereinafter, the closed magnetic circuit type coil component will be described. In the following description, differences from the toroidal type coil component will mainly be described, and description of similar matters will be omitted.

A coil component 20 shown in FIG. 4 includes a dust core 21 having a chip shape and a conductive wire 22 embedded in the dust core 21 and formed into a coil shape. That is, the dust core 21 is a green compact containing the soft magnetic alloy powder according to the embodiment. Such a dust core 21 has a low coercive force and a low iron loss.

The coil component 20 includes the dust core 21. Such a coil component 20 has a low iron loss and contributes to power saving of an electronic device.

The dust core 21 may contain, as necessary, a soft magnetic powder other than the soft magnetic alloy powder according to the embodiment described above, or a non-magnetic powder.

### 4. Electronic Device

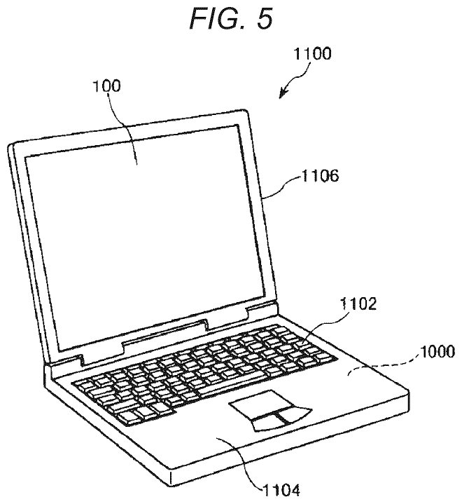

Next, the electronic device including the magnetic element according to the embodiment will be described with reference to FIGS. 5 to 7.

FIG. 5 is a perspective view showing a mobile personal computer which is an electronic device including the magnetic element according to the embodiment. A personal computer 1100 shown in FIG. 5 includes a main body 1104 including a keyboard 1102 and a display unit 1106 including a display 100. The display unit 1106 is pivotally supported by the main body 1104 via a hinge structure. Such a personal computer 1100 includes therein a magnetic element 1000 such as a choke coil, an inductor, or a motor for a switching power supply.

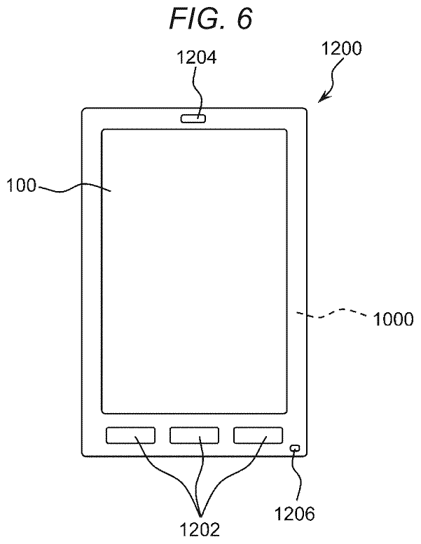

FIG. 6 is a plan view showing a smartphone which is an electronic device including the magnetic element according to the embodiment. A smartphone 1200 shown in FIG. 6 includes a plurality of operation buttons 1202, an earpiece 1204, and a mouthpiece 1206. The display 100 is disposed between the operation buttons 1202 and the earpiece 1204. Such a smartphone 1200 includes therein the magnetic element 1000 such as an inductor, a noise filter, or a motor.

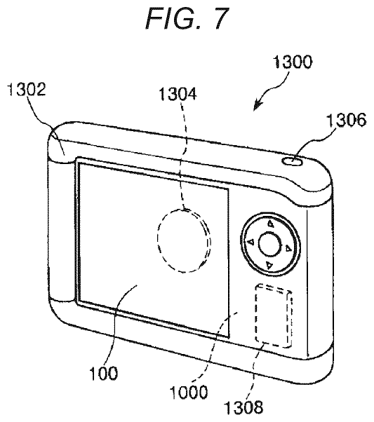

FIG. 7 is a perspective view showing a digital still camera which is an electronic device including the magnetic element according to the embodiment. A digital still camera 1300 photoelectrically converts an optical image of a subject by an imaging element such as a charge coupled device (CCD) so as to generate an imaging signal.

The digital still camera 1300 shown in FIG. 7 includes the display 100 provided at a rear surface of a case 1302. The display 100 functions as a finder which displays a subject as an electronic image. A light receiving unit 1304 including an optical lens, a CCD, and the like is provided on a front surface side of the case 1302, that is, on a back surface side in the drawing. When a photographer confirms a subject image displayed on the display 100 and presses a shutter button 1306, a CCD imaging signal at this time is transferred to and stored in a memory 1308. Such a digital still camera 1300 also includes therein the magnetic element 1000 such as an inductor or a noise filter.

Examples of the electronic device according to the embodiment include, in addition to the personal computer in FIG. 5, the smartphone in FIG. 6, and the digital still camera in FIG. 7, a mobile phone, a tablet terminal, a watch, inkjet discharge devices such as an inkjet printer, a laptop personal computer, a television, a video camera, a video tape recorder, a car navigation device, a pager, an electronic notebook, an electronic dictionary, a calculator, an electronic game device, a word processor, a workstation, a videophone, a crime prevention television monitor, electronic binoculars, a POS terminal, medical devices such as an electronic thermometer, a blood pressure meter, a blood glucose meter, an electrocardiogram measurement device, an ultrasonic diagnostic device, and an electronic endoscope, a fish finder, various measuring devices, instruments for a vehicle, an aircraft, and a ship, moving object control devices such as an automobile control device, an aircraft control device, a railway vehicle control device, and a ship control device, and a flight simulator.

Such an electronic device includes the magnetic element according to the embodiment. Accordingly, it is possible to enjoy the advantages of the magnetic element with a low iron loss and to achieve power saving of the electronic device.

### 5. Effects of Embodiment

As described above, a method for producing a soft magnetic alloy powder according to the embodiment includes: the powder production step S102 of producing an amorphous alloy powder that has an average particle diameter of 10.0 μm or more and 45.0 μm or less and that is formed of impurities and a composition represented by a composition formula FeₓCuₐNb_{b} (Si_{1-y}B_{y})_{100-x-a-b} in atomic ratio, where a, b, and x satisfy 0.3≤a≤2.0, 2.0≤b≤4.0, and 72.5≤x<75.5, and y is a number that satisfies f(x)≤y≤0.99, and f(x)=(4×10⁻³⁴)x^{17.56}; and the heat treatment step S104 of subjecting the amorphous alloy powder to a heat treatment at a temperature of 500° C. or higher and 600° C. or lower to crystallize the amorphous alloy powder, to produce a soft magnetic alloy powder containing 30 vol % or more of crystal grains having a crystal grain size of 1.0 nm or more and 30.0 nm or less. Further, when the soft magnetic alloy powder is pressurized at a pressure of 63.7 MPa to produce a green compact having a mass of 7.0 g, the green compact has a volume resistivity of 10.0×10⁻³ [Ω·cm] or less.

According to such a configuration, the stress strain of the amorphous alloy powder can be sufficiently relaxed, and the soft magnetic alloy powder having a low coercive force can be produced. In addition, it is possible to obtain the soft magnetic alloy powder with less variation in coercive force and stable quality.

In the method for producing the soft magnetic alloy powder according to the embodiment, a heat treatment time is 5 minutes or more and 60 minutes or less.

According to such a configuration, the amorphous alloy powder can be appropriately crystallized, and the stress strain can be sufficiently relaxed.

In the method for producing the soft magnetic alloy powder according to the embodiment, a coercive force of the soft magnetic alloy powder is 8.0 [A/m] (0.1 [e]) or more and 79.6 [A/m] (1.0 [Oe]) or less.

According to such a configuration, it is possible to obtain the soft magnetic alloy powder capable of producing a dust core having a particularly low coercive force and a sufficiently reduced hysteresis loss.

In the method for producing the soft magnetic alloy powder according to the embodiment, a heat treatment is performed under a pressure of 5 Pa or more and 1000 Pa or less, which is a positive pressure.

According to such a configuration, the soft magnetic alloy powder as a whole can have a lower coercive force. In addition, during the heat treatment, a gas is present in a narrow space between the particles of the amorphous alloy powder, and the gas mediates thermal conduction while being affected by the distance between the particles, and thus it is considered that the thermal conductivity between the particles is likely to be affected by pressure. Therefore, by performing the heat treatment under the above-described pressure, the variation in temperature in the heat treatment can be reduced.

In the method for producing the soft magnetic alloy powder according to the embodiment, the heat treatment is performed in an inert atmosphere having an oxygen volume concentration of 1500 ppm or less.

According to such a configuration, oxidation of the amorphous alloy powder can be more reliably prevented. In addition, since the formation of the oxide film on the surface of the particle can be prevented, it is possible to prevent the stress strain from being less likely to be relaxed.

A soft magnetic alloy powder according to the embodiment includes: impurities and a composition represented by a composition formula FeₓCuₐNb_{b} (Si_{1-y}B_{y})_{100-x-a-b} in atomic ratio, where a, b, and x are each a number expressed in atomic %, which satisfy 0.3≤a≤ 2.0, 2.0≤b≤ 4.0, and 72.5≤x<75.5, and y is a number that satisfies f(x)≤y≤0.99, and f(x)=(4×10⁻³⁴)x^{17.56}. The soft magnetic alloy powder has an average particle diameter of 10.0 μm or more and 45.0 μm or less, contains 30 vol % or more of crystal grains having a crystal grain size of 1.0 nm or more and 30.0 nm or less, and when the soft magnetic alloy powder is pressurized at a pressure of 63.7 MPa to produce a green compact having a mass of 7.0 g, volume resistivity of the green compact is 10.0×10⁻³ [Ω·cm] or less.

According to such a configuration, it is possible to obtain a soft magnetic alloy powder having a low coercive force and a small variation in the coercive force.

In the soft magnetic alloy powder according to the embodiment, a coercive force thereof is 8.0 [A/m] (0.1 [De]) or more and 79.6 [A/m] (1.0 [De]) or less.

According to such a configuration, it is possible to obtain the soft magnetic alloy powder capable of producing a dust core capable of sufficiently reducing a hysteresis loss.

The dust core according to the embodiment includes the soft magnetic alloy powder according to the embodiment.

According to such a configuration, it is possible to obtain a dust core having a low coercive force and a low iron loss.

The magnetic element according to the embodiment includes the dust core according to the embodiment.

According to such a configuration, the iron loss is low, and it is possible to contribute to power saving of the electronic device.

The electronic device according to the embodiment includes the magnetic element according to the embodiment.

According to such a configuration, it is possible to enjoy the advantages of the magnetic element with a low iron loss and to achieve power saving of the electronic device.

The method for producing a soft magnetic alloy powder, a soft magnetic alloy powder, a dust core, magnetic element, and an electronic device according to the present disclosure are described above based on a preferred embodiment, and the present disclosure is not limited thereto. For example, the dust core and the magnetic element according to the present disclosure may be what is obtained by replacing each unit of the embodiment described above with any component having the same function, or what is obtained by adding any constituent to the embodiment described above.

In addition, in the above embodiment, a dust core is described as an example of an application of the soft magnetic alloy powder of the present disclosure, and the application example is not limited thereto, and may be, for example, a magnetic fluid, a magnetic shielding sheet, and a magnetic device such as a magnetic head. In addition, shapes of the dust core and the magnetic element are not limited to those shown in the drawings, and any shapes may be adopted.

The method for producing the soft magnetic alloy powder according to the present disclosure may be one in which any desired process is added to the above embodiment.

### EXAMPLES

Next, specific examples of the disclosure will be described.

### 6. Production of Dust Core

### 6.1. Sample Nos. 1 to 14

First, a raw material was melted in a high-frequency induction furnace and pulverized by a rotary water jet atomization method to obtain an amorphous alloy powder.

Next, the obtained amorphous alloy powder was subjected to the heat treatment under conditions shown in Table 1. Accordingly, a soft magnetic alloy powder was obtained.

Next, classification performed by classifier using a mesh. An alloy composition of the soft magnetic alloy powder after the classification is shown in Table 1. The values of x and y determined from the alloy composition are plotted on the graph shown in FIG. 1, and when the alloy composition falls within any of regions A to C, the symbol is shown in Table 1.

Next, the classified soft magnetic alloy powder was mixed with an epoxy resin as a binder and toluene as an organic solvent to obtain a mixture. An addition amount of the epoxy resin was 2 parts by mass with respect to 100 parts by mass of the soft magnetic alloy powder.

Then, the mixture thus obtained was stirred and then dried for a short time to obtain a massive dried body. Next, the dried body was sieved with a sieve having an opening of 400 μm, and the dried body was pulverized to obtain granulated powders. The obtained granulated powders were dried at 50° C. for 1 hour.

Next, the obtained granulated powders were filled in a mold, and a molded body was obtained based on the following molding conditions.

### Molding Conditions

Molding method: press molding
Shape of molded body: ring shape
Dimensions of molded body: outer diameter 14 mm, inner diameter 8 mm, thickness 3 mm
Molding pressure: 0.5 t/cm² (49 MPa)
Molding temperature: 70° C.

Next, the molded body was heated in an air atmosphere at a temperature of 150° C. for 0.50 hours to cure the binder. Accordingly, a dust core was obtained.

Table 2 shows an average particle diameter of the soft magnetic alloy powder used in the production of the dust core, a content ratio of crystal grains, and volume resistivity of the green compact. The measurement of the average particle diameter was carried out using a particle size distribution measurement device using a laser diffraction method, Microtrac HRA9320-X100 manufactured by Nikkiso Co., Ltd.

### 6.2. Sample Nos. 15 to 33

A dust core was obtained in the same manner as in the case of Sample Nos. 1 to 14, except that a soft magnetic alloy powder was used, which was produced under the production conditions shown in Table 3 and had the average particle diameter of the soft magnetic alloy powder, the content ratio of crystal grains, and the volume resistivity of the green compact indicated by values shown in Table 4.

In Tables 1 to 4, among the soft magnetic alloy powders of the respective sample numbers, those produced by a method corresponding to the present disclosure are indicated as “Examples”, and those not corresponding to the present disclosure are indicated as “Comparative Examples”.

TABLE 1

| | | | | | | | | | | | Heat treatment conditions | | | |
|---|---|---|---|---|---|---|---|---|---|---|---|---|---|---|
| | | Composition of soft magnetic alloy powder | | | | | | | | | | | | Oxygen |
| | | | | | | | | | B/ | | Heating | | | volume |
| | Example/ | Fe | Cu | Nb | | | | | (Si + B) | Graph | Tempera- | | Positive | concentration |
| Sample | Comparative | x | a | b | Si | B | Total | Si + B | y | Region | ture | Time | pressure | in furnace |
| No. | Example | Atomic % | | | | | Atomic % | Atomic % | — | — | ° C. | Min(s) | Pa | ppm |
| No. 1 | Comparative | 73.5 | 1.0 | 3.0 | 13.5 | 9.0 | 100 | 22.5 | 0.40 | A | — | — | — | — |
| | Example | | | | | | | | | | | | | |
| No. 2 | Comparative | 73.5 | 1.0 | 3.0 | 13.5 | 9.0 | 100 | 22.5 | 0.40 | A | 480 | 15 | 50 | 450 |
| | Example | | | | | | | | | | | | | |
| No. 3 | Example | 73.5 | 1.0 | 3.0 | 13.5 | 9.0 | 100 | 22.5 | 0.40 | A | 500 | 15 | 50 | 540 |
| No. 4 | Example | 73.5 | 1.0 | 3.0 | 13.5 | 9.0 | 100 | 22.5 | 0.40 | A | 520 | 15 | 50 | 580 |
| No. 5 | Example | 73.5 | 1.0 | 3.0 | 13.5 | 9.0 | 100 | 22.5 | 0.40 | A | 540 | 15 | 50 | 640 |
| No. 6 | Example | 73.5 | 1.0 | 3.0 | 13.5 | 9.0 | 100 | 22.5 | 0.40 | A | 560 | 15 | 50 | 700 |
| No. 7 | Example | 73.5 | 1.0 | 3.0 | 13.5 | 9.0 | 100 | 22.5 | 0.40 | A | 580 | 15 | 50 | 750 |
| No. 8 | Example | 73.5 | 1.0 | 3.0 | 13.5 | 9.0 | 100 | 22.5 | 0.40 | A | 600 | 15 | 50 | 900 |
| No. 9 | Example | 73.5 | 1.0 | 3.0 | 13.5 | 9.0 | 100 | 22.5 | 0.40 | A | 560 | 5 | 50 | 700 |
| No. 10 | Example | 73.5 | 1.0 | 3.0 | 13.5 | 9.0 | 100 | 22.5 | 0.40 | A | 560 | 30 | 50 | 700 |
| No. 11 | Example | 73.5 | 1.0 | 3.0 | 13.5 | 9.0 | 100 | 22.5 | 0.40 | A | 560 | 60 | 50 | 700 |
| No. 12 | Example | 73.5 | 1.0 | 3.0 | 13.5 | 9.0 | 100 | 22.5 | 0.40 | A | 560 | 15 | 0 | 700 |
| No. 13 | Example | 73.5 | 1.0 | 3.0 | 13.5 | 9.0 | 100 | 22.5 | 0.40 | A | 560 | 15 | 20 | 700 |
| No. 14 | Comparative | 73.5 | 1.0 | 3.0 | 13.5 | 9.0 | 100 | 22.5 | 0.40 | A | 620 | 15 | 50 | 1050 |
| | Example | | | | | | | | | | | | | |

TABLE 2

| | | Configuration of soft | | | | | | |
|---|---|---|---|---|---|---|---|---|
| | | magnetic alloy powder | | | | | | |
| | | | Content | | Evaluation result | | | |
| | | Average | ratio of | Volume | | Coercive | | |
| | Example/ | particle | crystal | resistivity of | Coercive | force | | |
| Sample | Comparative | diameter | grains | green compact | force | variation | Permeability | Iron loss |
| No. | Example | μm | Vol % | ×10⁻³ Ω · cm | Oe | — | — | kW/m³ |
| No. 1 | Comparative | 25.0 | 0 | 11.0 | 1.18 | A | B | 1000 |
| | Example | | | | | | | |
| No. 2 | Comparative | 25.0 | 25 | 6.5 | 0.70 | D | A | 592 |
| | Example | | | | | | | |
| No. 3 | Example | 25.0 | 50 | 5.1 | 0.55 | B | A | 455 |
| No. 4 | Example | 25.0 | 52 | 4.5 | 0.48 | A | A | 397 |
| No. 5 | Example | 25.0 | 54 | 4.6 | 0.49 | A | A | 406 |
| No. 6 | Example | 25.0 | 56 | 3.6 | 0.39 | A | A | 323 |
| No. 7 | Example | 25.0 | 58 | 4.0 | 0.43 | A | A | 356 |
| No. 8 | Example | 25.0 | 60 | 7.4 | 0.69 | A | A | 554 |
| No. 9 | Example | 25.0 | 45 | 6.1 | 0.65 | B | A | 538 |
| No. 10 | Example | 25.0 | 75 | 3.3 | 0.39 | A | A | 323 |
| No. 11 | Example | 25.0 | 90 | 3.2 | 0.41 | A | A | 340 |
| No. 12 | Example | 25.0 | 48 | 4.8 | 0.51 | C | B | 422 |
| No. 13 | Example | 25.0 | 52 | 4.4 | 0.47 | B | A | 389 |
| No. 14 | Comparative | 25.0 | 28 | 14.2 | 1.52 | B | B | 1259 |
| | Example | | | | | | | |

TABLE 3

| | | | | | | | | | | | Heat treatment conditions | | | |
|---|---|---|---|---|---|---|---|---|---|---|---|---|---|---|
| | | Composition of soft magnetic alloy powder | | | | | | | | | | | | Oxygen |
| | | | | | | | | | B/ | | Heating | | | volume |
| | Example/ | Fe | Cu | Nb | | | | | (Si + B) | Graph | Temp- | | Positive | concentration |
| Sample | Comparative | x | a | b | Si | B | Total | Si + B | y | Region | erature | Time | pressure | in furnace |
| No. | Example | Atomic % | | | | | Atomic % | Atomic % | — | — | ° C. | Min(s) | Pa | ppm |
| No. 15 | Comparative | 72.0 | 1.0 | 3.0 | 14.4 | 9.6 | 100 | 24.0 | 0.40 | — | 560 | 10 | 100 | 550 |
| | Example | | | | | | | | | | | | | |
| No. 16 | Comparative | 72.0 | 1.0 | 3.0 | 4.8 | 19.2 | 100 | 24.0 | 0.80 | — | 560 | 10 | 100 | 550 |
| | Example | | | | | | | | | | | | | |
| No. 17 | Comparative | 73.0 | 1.0 | 3.0 | 19.6 | 3.5 | 100 | 23.0 | 0.15 | — | 560 | 10 | 100 | 550 |
| | Example | | | | | | | | | | | | | |
| No. 18 | Example | 73.0 | 1.0 | 3.0 | 13.8 | 9.2 | 100 | 23.0 | 0.40 | A | 560 | 10 | 100 | 550 |
| No. 19 | Example | 73.5 | 1.0 | 3.0 | 15.8 | 6.8 | 100 | 22.5 | 0.30 | B | 560 | 10 | 100 | 550 |
| No. 20 | Example | 73.5 | 1.0 | 3.0 | 13.5 | 9.0 | 100 | 22.5 | 0.40 | A | 560 | 10 | 100 | 550 |
| No. 21 | Example | 73.5 | 1.0 | 3.0 | 11.3 | 11.3 | 100 | 22.5 | 0.50 | A | 560 | 10 | 100 | 550 |
| No. 22 | Example | 73.5 | 1.0 | 3.0 | 9.0 | 13.5 | 100 | 22.5 | 0.60 | A | 560 | 10 | 100 | 550 |
| No. 23 | Example | 73.5 | 1.0 | 3.0 | 6.8 | 15.8 | 100 | 22.5 | 0.70 | A | 560 | 10 | 100 | 550 |
| No. 24 | Example | 73.5 | 1.0 | 3.0 | 4.5 | 18.0 | 100 | 22.5 | 0.80 | A | 560 | 10 | 100 | 550 |
| No. 25 | Example | 73.5 | 1.0 | 3.0 | 2.3 | 20.3 | 100 | 22.5 | 0.90 | A | 560 | 10 | 100 | 550 |
| No. 26 | Example | 74.0 | 1.0 | 3.0 | 12.1 | 9.9 | 100 | 22.0 | 0.45 | A | 560 | 10 | 100 | 550 |
| No. 27 | Example | 74.5 | 1.0 | 3.0 | 10.8 | 10.8 | 100 | 21.5 | 0.50 | A | 560 | 10 | 100 | 550 |
| No. 28 | Example | 74.5 | 1.0 | 3.0 | 6.5 | 15.1 | 100 | 21.5 | 0.70 | A | 560 | 10 | 100 | 550 |
| No. 29 | Example | 75.0 | 1.0 | 3.0 | 8.4 | 12.6 | 100 | 21.0 | 0.60 | B | 560 | 10 | 100 | 550 |
| No. 30 | Example | 75.0 | 1.0 | 3.0 | 4.2 | 16.8 | 100 | 21.0 | 0.80 | B | 560 | 10 | 100 | 550 |
| No. 31 | Comparative | 75.0 | 1.0 | 3.0 | 14.7 | 6.3 | 100 | 21.0 | 0.30 | — | 560 | 10 | 100 | 550 |
| | Example | | | | | | | | | | | | | |
| No. 32 | Comparative | 76.0 | 1.0 | 3.0 | 10.0 | 10.0 | 100 | 20.0 | 0.50 | — | 560 | 10 | 100 | 550 |
| | Example | | | | | | | | | | | | | |
| No. 33 | Comparative | 76.0 | 1.0 | 3.0 | 4.0 | 16.0 | 100 | 20.0 | 0.80 | — | 560 | 10 | 100 | 550 |
| | Example | | | | | | | | | | | | | |

TABLE 4

| | | Configuration of | | | | | | |
|---|---|---|---|---|---|---|---|---|
| | | soft magnetic alloy powder | | | Evaluation result | | | |
| | | Average | Content ratio | Volume | | Coercive | | |
| | Example/ | particle | of crystal | resistivity of | Coercive | force | | Iron |
| Sample | Comparative | diameter | grains | green compact | force | variation | Permeability | loss |
| No. | Example | μm | Vol % | ×10⁻³ Ω · cm | Oe | — | — | kW/m³ |
| No. 15 | Comparative | 24.0 | 38 | 6.1 | 0.65 | D | C | 538 |
| | Example | | | | | | | |
| No. 16 | Comparative | 24.5 | 21 | 5.8 | 0.62 | D | C | 513 |
| | Example | | | | | | | |
| No. 17 | Comparative | 25.5 | 28 | 5.7 | 0.61 | D | C | 505 |
| | Example | | | | | | | |
| No. 18 | Example | 26.0 | 67 | 3.5 | 0.37 | B | A | 306 |
| No. 19 | Example | 22.0 | 45 | 4.8 | 0.51 | C | A | 422 |
| No. 20 | Example | 25.0 | 71 | 3.3 | 0.35 | A | A | 290 |
| No. 21 | Example | 20.5 | 73 | 3.5 | 0.37 | A | A | 306 |
| No. 22 | Example | 19.5 | 81 | 3.8 | 0.41 | B | A | 339 |
| No. 23 | Example | 18.0 | 83 | 5.2 | 0.56 | B | A | 464 |
| No. 24 | Example | 18.5 | 65 | 5.4 | 0.58 | B | A | 480 |
| No. 25 | Example | 20.0 | 54 | 5.6 | 0.60 | C | A | 497 |
| No. 26 | Example | 22.0 | 85 | 3.4 | 0.36 | B | A | 298 |
| No. 27 | Example | 23.0 | 85 | 3.6 | 0.39 | B | A | 323 |
| No. 28 | Example | 23.0 | 85 | 3.9 | 0.42 | B | A | 348 |
| No. 29 | Example | 11.5 | 85 | 4.3 | 0.46 | C | A | 381 |
| No. 30 | Example | 15.0 | 85 | 4.5 | 0.48 | C | A | 397 |
| No. 31 | Comparative | 22.5 | 25 | 6.4 | 0.68 | D | A | 563 |
| | Example | | | | | | | |
| No. 32 | Comparative | 25.0 | 12 | 7.4 | 0.79 | D | B | 654 |
| | Example | | | | | | | |
| No. 33 | Comparative | 26.0 | 10 | 8.2 | 0.88 | D | B | 729 |
| | Example | | | | | | | |

### 7. Evaluation of Soft Magnetic Alloy Powder

### 7.1. Coercive Force of Soft Magnetic Alloy Powder

The coercive force of the soft magnetic alloy powder obtained in each of the Examples and Comparative Examples was measured. The measurement results are shown in Tables 2 and 4.

### 7.2. Variation in Coercive Force of Soft Magnetic Alloy Powder

The variation in the coercive force of the soft magnetic alloy powder obtained in each of the Examples and Comparative Examples was evaluated by the following method. The evaluation results are shown in Tables 2 and 4.

First, 50 g of the soft magnetic alloy powder was prepared and divided into 10 equal parts. Further, the coercive force of each of the equal parts was then measured, and a range of measurement values ((difference between a maximum value and a minimum value) was evaluated against the following evaluation criteria.
A: The range of measurement values is particularly small.
B: The range of measurement values is slightly large, but there is little problem in practical use.
C: The range of measurement values is large, and there is a slight problem in practical use.
D: The range of measurement values is particularly large, and there are many problems in practical use.

### 7.3. Permeability of Magnetic Element

Using the dust core obtained in each of Examples and Comparative Examples, the magnetic elements were produced under the following production conditions.
Constituent material of conductive wire: Cu
Wire diameter of conductive wire: 0.6 mm
Number of turns: 7 turns

Next, the permeability of the produced magnetic element was measured under the following measurement conditions.
Measurement device: Impedance Analyzer 4294A, manufactured by Keysight Technologies
Measurement frequency: 1 MHZ

Then, the obtained permeability was evaluated in view of the following evaluation criteria. The evaluation results are shown in Tables 2 and 4.
A: Permeability is 24.5 or more.
B: Permeability is 23.0 or more and less than 24.5.
C: Permeability is less than 23.0.

### 7.4. Iron Loss of Magnetic Element

Using the dust core obtained in each of Examples and Comparative Examples, the magnetic elements were produced under the following production conditions.
Constituent material of conductive wire: Cu
Wire diameter of conductive wire: 0.16 mm
Number of turns: 18 turns on a primary side, 18 turns on a secondary side

Next, the iron loss of the produced magnetic element was measured under the following measurement conditions. The measurement results are shown in Tables 2 and 4.
Measurement device: BH analyzer SY-8218, manufactured by Iwasaki Electric Co., Ltd.
Measurement frequency: 1 MHZ
Maximum magnetic flux density: 20 mT

As shown in Tables 2 and 4, it is found that the soft magnetic alloy powders obtained in the respective Examples have lower coercive forces than the soft magnetic alloy powders obtained in the respective Comparative Examples. In addition, the variation in coercive force is kept small.

Furthermore, it is also found that the soft magnetic alloy powders obtained in the respective Examples have good permeability and a low core loss.

What is claimed is:

1. A method for producing a soft magnetic alloy powder, comprising:
a powder production step of producing an amorphous alloy powder that has an average particle diameter of 10.0 μm or more and 45.0 μm or less and that is formed of impurities and a composition represented by a composition formula FeₓCuₐNb_{b} (Si_{1-y}B_{y})_{100-x-a-b} in atomic ratio, where a, b, and x satisfy 0.3≤a≤2.0, 2.0≤b≤4.0, and 72.5≤x<75.5, and y is a number that satisfies f(x)≤y≤0.99, and f(x)=(4×10⁻³⁴)×17.56; and
a heat treatment step of subjecting the amorphous alloy powder to a heat treatment at a temperature of 500° C. or higher and 600° C. or lower to crystallize the amorphous alloy powder, to produce a soft magnetic alloy powder containing 30 vol % or more of crystal grains having a crystal grain size of 1.0 nm or more and 30.0 nm or less, wherein
when the soft magnetic alloy powder is pressurized at a pressure of 63.7 MPa to produce a green compact having a mass of 7.0 g, volume resistivity of the green compact is 10.0×10⁻³ [Ω·cm] or less.

2. The method for producing a soft magnetic alloy powder according to claim 1, wherein a heat treatment time is 5 minutes or longer and 60 minutes or shorter.

3. The method for producing a soft magnetic alloy powder according to claim 1, wherein a coercive force of the soft magnetic alloy powder is 8.0 [A/m] (0.1 [Oe]) or more and 79.6 [A/m] (1.0 [Oe]) or less.

4. The method for producing a soft magnetic alloy powder according to claim 1, wherein the heat treatment is performed under a pressure of 5 Pa or more and 1000 Pa or less, which is a positive pressure.

5. The method for producing a soft magnetic alloy powder according to claim 1, wherein the heat treatment is performed in an inert atmosphere having an oxygen volume concentration of 1500 ppm or less.

6. A soft magnetic alloy powder comprising:
impurities and a composition represented by a composition formula FeₓCuₐNb_{b} (Si_{1-y}B_{y})_{100-x-a-b} in atomic ratio, where a, b, and x are each a number expressed in atomic %, which satisfy 0.3≤a≤ 2.0, 2.0≤b≤4.0, and 72.5≤x<75.5, and y is a number that satisfies f(x)≤y≤0.99, and f(x)=(4×10⁻³⁴)x^{17.56}, wherein
the soft magnetic alloy powder has an average particle diameter of 10.0 μm or more and 45.0 μm or less, and contains 30 vol % or more of crystal grains having a crystal grain size of 1.0 nm or more and 30.0 nm or less, and
when the soft magnetic alloy powder is pressurized at a pressure of 63.7 MPa to produce a green compact having a mass of 7.0 g, volume resistivity of the green compact is 10.0×10⁻³ [Ω·cm] or less.

7. The soft magnetic alloy powder according to claim 6, wherein
a coercive force is 8.0 [A/m] (0.1 [Oe]) or more and 79.6 [A/m] (1.0 [Oe]) or less.

8. A dust core comprising:
the soft magnetic alloy powder according to claim 6.

9. A magnetic element comprising:
the dust core according to claim 8.

10. An electronic device comprising:
the magnetic element according to claim 9.
